(19) United States
(12) Patent Application Publication
(10) Pub. No.: US 2022/0022438 A1
(43) Pub. Date: Jan. 27, 2022

(54) COLLAPSIBLE BAIT NET

(71) Applicant: Yunior Dominguez, Hialeah, FL (US)

(72) Inventor: Yunior Dominguez, Hialeah, FL (US)

(21) Appl. No.: 16/935,245

(22) Filed: Jul. 22, 2020

(51) Int. Cl. A01K 97/05; A01K 63/02

(52) U.S. Cl. CPC A01K 97/05; A01K 63/02

(57) ABSTRACT

The present invention is a collapsible bait net comprising netting mounted to one or more straight solid rod(s) irremovably connected by an irremovably joined fastener, forming a closed ring and net assembly that maintains its shape and structural integrity. The fastener is irremovably joined in a manner that provides a 360 degree range of motion about the rod(s). The assembly includes four stabilizing cords positioned equidistant from each other along the circumference of the closed ring, which cords converge at the center of the assembly, connecting to each other by a fastening means. The four stabilizing cords are connected to a single draw cord which is used to cast the bait net into a desired depth of water then pull it back. The assembly collapses for easy storage by rotating into a figure 8 arrangement that is folded from top to bottom to create two smaller overlapping closed rings.

### STATEMENT REGARDING FEDERALLY SPONSORED RESEARCH OR DEVELOPMENT

This invention has been created without the sponsorship or funding of any federally sponsored research or development program.

### FIELD OF INVENTION

The present invention relates to generally to fishing bait nets and in particular to collapsible bait nets for easy storage and transport.

### BACKGROUND

In the fishing industry, whether for sport or for profit, bait nets are used to capture small fish and/or sea creatures for use as bait to attract bigger fish such as marlin, tuna, tarpon or similar fish. The bait nets usually used by fishermen come in varying forms, sizes, and shapes, but invariable are too cumbersome to store and transport. In particular, the bait nets used to catch larger bait need to be sturdy and able to withstand the rigors of being cast into the ocean from a moving or stationary vessel, dragged through water, and pulled back into a boat. In instances where the bait net is sturdy enough to handle this rigorous activity, they are not easily stored on or off the boat or transportable from one venue to another. The rigid construct of most good bait nets results in rapid deterioration through sun exposure or tearing due to improper storage on a boat or in a garage or other location not suitable to protect the delicate netting.

The present invention solves these problems by providing a collapsible hoop net that is strong and sturdy to endure the rigors of capturing bait, and which is capable of being stored and transported with ease. The essential feature of this invention allows for the collapsing of the hoop net for easy and efficient storage on the boat in a location that minimizes sun exposure and rapid deterioration. Alternatively, the collapsible/folded hoop net may be stored in another location or may be packaged in a protective casing.

### SUMMARY OF THE INVENTION

The present invention serves to improve upon existing bait nets and address the storage and transport challenges facing the industry without sacrificing the strength and rigidity the bait net.

The present invention is a hoop net comprised of netting that is affixed or mounted to one or more straight solid rods, which when assembled form one complete ring that maintains its shape and integrity. The rod(s) is/are fashioned to connect seamlessly by a fastening means which allow(s) the entire assembly to function as intended. Additionally, the position of the net about the rods is designed to evenly distribute weight and improve the overall balance of the assembly. The net is affixed to the rod(s) and extends in a conical shape, creating a hoop or enclosed receptacle for capturing and holding live bait as they are pulled from the water into a boat. Further, the hoop net and rod components of the invention also include four stabilizing cords positioned equidistant along the circumference ring created by connected or joined straight solid rod(s), which cords converge at the center of the hoop by a fastening means to a single draw cord. The draw cord is used to cast or lower the assembled hoop net into the water to a desired depth and pull the hoop net back into the boat with bait. Once the hoop net assembly has been used, the solid rod(s) is/are twisted or rotated to form a figure 8 which allows for the hoop net to collapse or folded onto itself. The solid rod(s) is/are not disconnected, but have a 360 degree range of rotation about the fastener to facilitate the folding or collapsing of the hoop net in half for easy storage in a bin on the boat or protective casing designed to accommodate the folded hoop net.

### BRIEF DESCRIPTION OF THE DRAWINGS

The accompanying drawings incorporated in and forming a part of the specification, illustrate several aspects of the present invention, and together with the description serve to explain the principles of the invention. In describing the invention, reference will at times be made to the accompanying drawings in which:

FIG. 1A is a perspective view of the two straight solid rods of one embodiment of the present invention;

FIG. 1B is a side perspective view of the unassembled fastening means of the present invention;

FIG. 1C is a side perspective view of the assembled fastening means of the present invention;

FIG. 1D is a side perspective view of the fastening means connected to the rod(s) of the present invention;

FIG. 2A is an enlarged top perspective view of the partially assembled components of the present invention;

FIG. 2B is an enlarged perspective view of the fully assembled components of the present invention;

FIG. 3A is a front perspective view of the present invention without netting for purposes of illustrating the folding/collapsing feature;

FIG. 3B is a side perspective view of the present invention without netting in its folded/collapsed state;

FIG. 4A is a front perspective view of the present invention with netting for purposes of illustrating the folding/collapsing feature;

FIG. 4B is a front perspective view of the present invention with netting in its folded/collapsed state;

FIG. 5A is a perspective view of the single straight solid rod component of one embodiment of the present invention;

FIG. 5B is a side perspective view of the fastening means connected to the single straight rod component of one embodiment of the present invention;

FIG. 5C is a front perspective view of the single rod embodiment of the present invention without netting for purposes of illustrating the folding/collapsing feature; and

FIG. 5D is a front perspective view of the single rod embodiment of the present invention with netting in its folded/collapsed state.

### DESCRIPTION OF THE INVENTION

Before the subject invention is described further, it is to be understood that the invention is not limited to the particular embodiments of the invention described below, as variations of the particular embodiments may be made and still fall within the scope of the invention. It is also to be understood that the terminology employed is for the purpose of describing particular embodiments and is not intended to be limiting.

The details of one or more embodiments of the invention are set forth in the accompanying drawings and the description below. Other features, objects, and advantages of the invention will be apparent from the description and drawings, and from the claims. In the following description, numerous specific details are set forth to provide a thorough understanding of the embodiments. One skilled in the art to which this invention belongs will recognize, however, that the techniques described can be practiced without one or more of the specific details, or with other methods, components, materials, etc. In other instances, well known structures, materials or operations are not shown or described in detail to avoid obscuring certain aspects.

In this specification, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

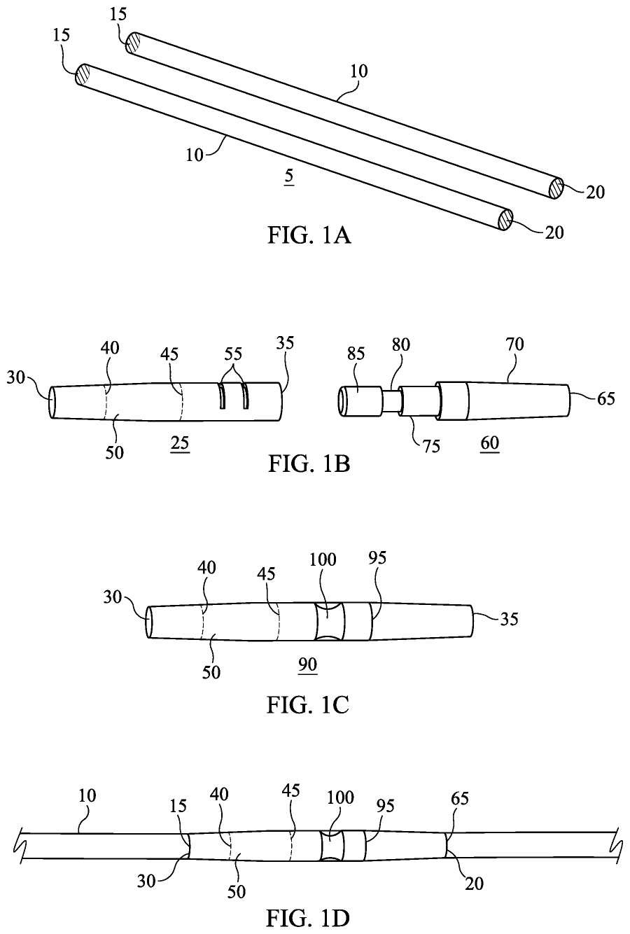

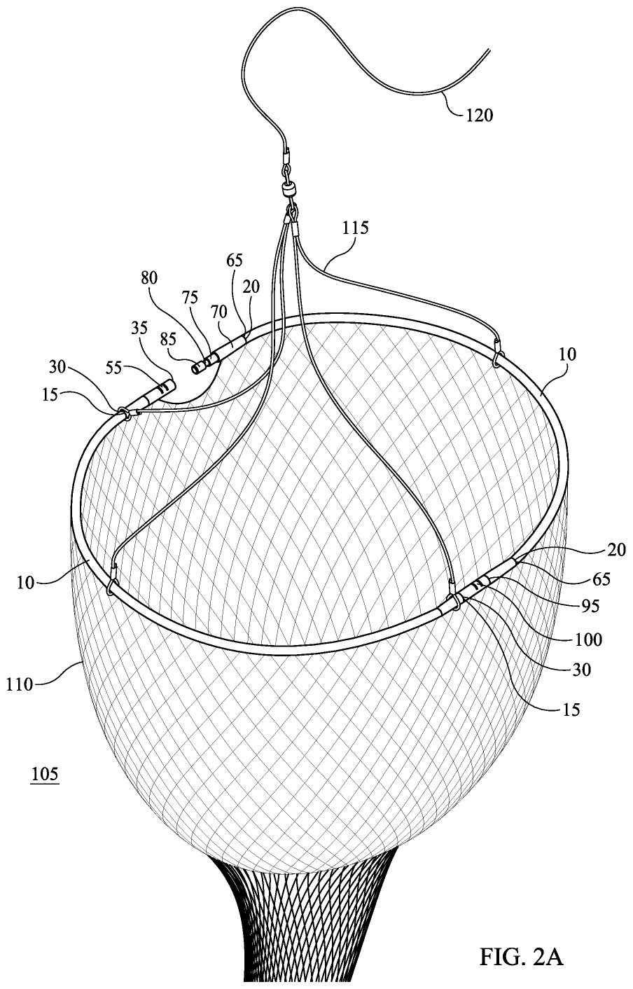

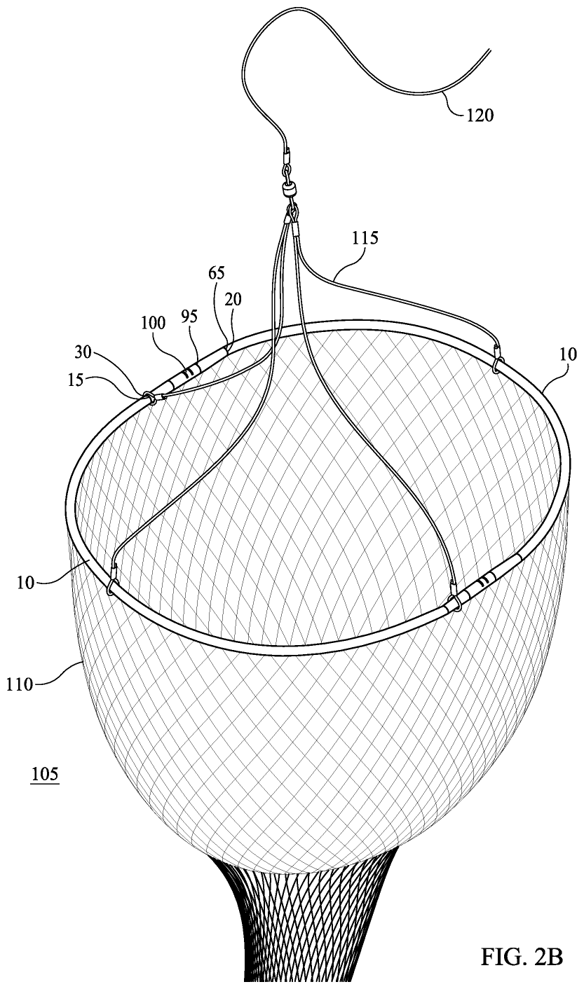

The present invention is a collapsible bait net comprised of straight solid rods 5, with each rod 10 having a first end 15 and a second end 20 as shown in FIG. 1A; a fastener 90 which has a female component 25 and a male 60 component that are joined together, as shown FIGS. 1B, 1C and 1D; netting 110 as shown in FIG. 2A; four stabilizing cords 115 as shown in FIG. 2A; and a draw cord 120. The female component 25 of the fastener 90 has a first end 30 and a second end 35, each end is hollow up to a point 40 and 45, with a solid middle section 50, as shown in FIG. 1B. The second end 35 of the female component has two grooves or notches 55 located along the hollow portion of the second end 35 as shown in FIG. 1B. The male component 60 of the fastener 90 also has a first end 65 which is hollow, and a second end 85 which is closed and rounded as shown in FIG. 1B. The male component 60 is comprised of three segments, 70, 75, and 80, as shown in FIG. 1B. The first segment 70 is a hollow cylindrical body that functions as the connection point for a solid rod 10; the second segment 75 is a solid cylindrical body that is contiguously connected to the first segment 70, whereby the second segment 75 is smaller or lesser in length and diameter or circumference than the first segment 70; and the third segment 80 is also a solid cylindrical body that is contiguously connected to the second segment 75, whereby the third segment 80 is smaller or lesser in length and diameter or circumference than both the first segment 70 and the second segment 75. The third segment 80 is also contiguously connected to the second end 85 of the male component 60.

As shown in FIG. 1C, the female component 25 joins with the male component 60 to form the fastener 90. The second solid end 85 of the male component 60 is inserted into the hollow second end 35 of the female component 25, whereby the second end 85 of the male component 60 aligns with or within the space between the two grooves or notches 55 and the point 45 adjacent to the solid body 50 of the female component 25. The second 75 and the third 80 segments of the male component 60 fit precisely inside the hollow portion of the second end 35 of the female component 25, whereby the third segment 80 is positioned precisely within the space between the two grooves or notches 55 located along the hollow portion of the second end 35 of the female component 25. The third 80 segment of the male component 60 is the same length as the space between the two notches 55 of the female component 25, whereby when pressure is applied to the space between the two notches 55 it collapses or compresses around the third 80 segment of the male component 60 to form a permanent and secure connection point or lock 100 for the fastener 90. The lock 100 permanently secures the male 60 and female 25 components together, preventing them from coming a apart during the normal and continuous use of the assembled bait net 105. This connection point 100 also provides a 360 degree range of rotation for the fastener 90 and the rods 5, 10 attached to the fastener 90. Once joined, the male component 60 and the female component 25 have a seam of attachment 95, whereby the first segment 70 of the male component 60 is visible and facilitates the connection to a rod 10; while the hollow first end 30 of the female component 25 facilitates the connection to a rod 10, as shown in FIG. 1D. In connecting the rods 5, 10 to the fastener 90, the ends of the rods 15, 20 are further secured by applying glue or resin such as that made from epoxy before inserting their solid ends 15, 20 into the hollow ends 30, 65 of the fastener 90. Upon connection, the rods 5, 10 have a 360 degree range of rotation by virtue of the secure connection point or lock 100 of the fastener 90.

In this embodiment of the present invention, the rods 5, 10 are made of fiber glass having the tensile strength to bend and twist without breaking. The level of flexibility of the fiber glass is very important to the ability of the bait net 105 to collapse or fold and unfold repeatedly without breaking. In this and other embodiments of the present invention, the rods 5, 10 may be made of durable and flexible plastics made from material such as epoxy resin, epoxy polymers, or other suitable polymers that allow for the required flexibility and strength.

As shown in FIG. 2A, a partially assembled and 2B, a fully assembled bait net 105 forms a large ring comprised of the two rods 5, 10 connected or joined together by the assembled fastener 90 having a secure lock 100, with netting 110, stabilizing cords 115, and a draw cord 120 attached to the rods 5,10. The netting 110 is interwoven around or about the solid rods 5, 10 along with the four stabilizing cords 115 positioned equidistant from each other around the large ring of the bait net 105. The net or netting 110 extends in a conical shape, creating a hoop or enclosed receptacle for capturing and holding live bait as they are pulled from the water into a boat. The netting 110 and the four stabilizing cords 115 are attached to the rods 5, 10, before the rods 5, 10 are connected to the fasteners 90 and glued or before the fastener components 25, 60 are permanently joined at the notches 55. The draw cord 120 is then attached to the four stabilizing cords 115 to complete the assembly. Alternatively, the draw cord 120 may be attached to the for stabilizing cords 115 before the four stabilizing cords 115 are attached to the large ring of the bait net assembly 105.

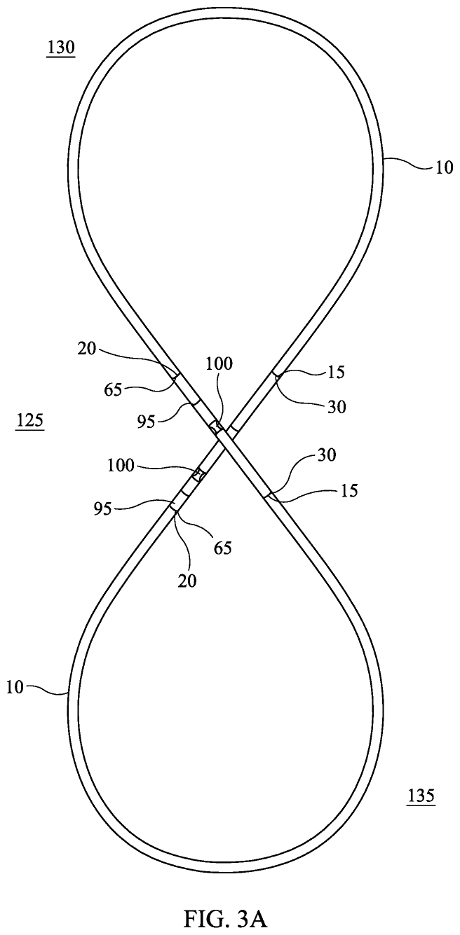

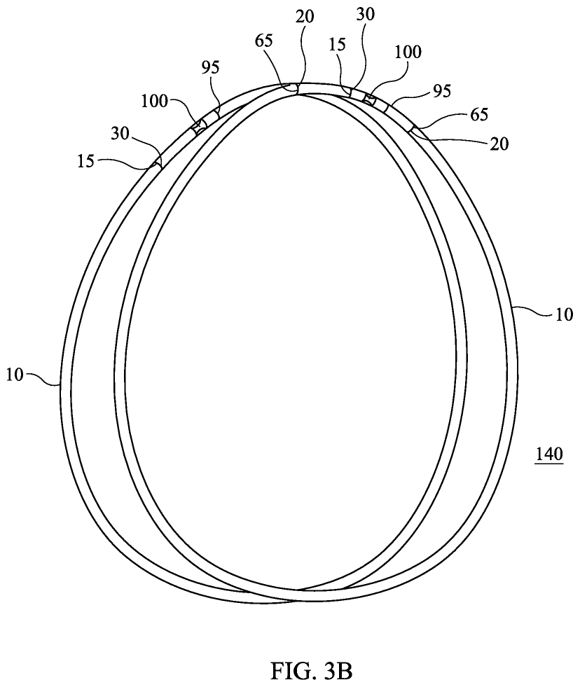

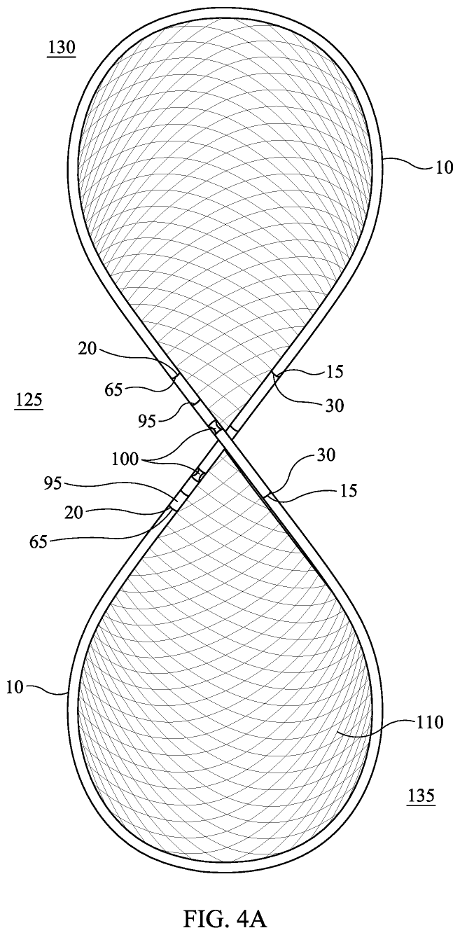

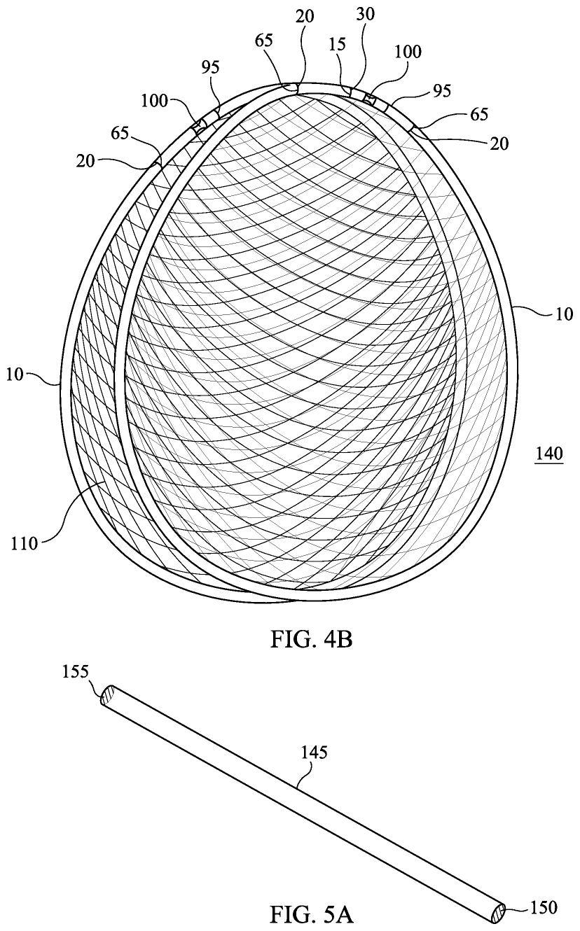

The assembled bait net 105 collapses into two smaller rings to facilitate storage and transport, as shown in FIGS. 3A, 3B, 4A, and 4B. For purposes of illustration, FIGS. 3A and 3B demonstrate the steps by which the bait net 105, without the netting 110, collapses and/or folds to form two smaller rings. First, a user holds the bait net 105 by the fasteners 90 and rotate or twist the rods 5, 10 to form a large figure 8 125 (FIG. 3A), creating a top portion 130 and a bottom portion 135. The user then folds the top portion 130 of the figure 8 125 downward until it overlaps with the bottom portion 135 of the figure 8 105 to form two smaller overlapping circles 140 (FIG. 3B). FIGS. 4A and 4B illustrate the same process for the fully assembled bait net 105, with netting 110, whereby the figure 8 125 formed includes a top portion 130 and a bottom portion 135, which top portion 130 is folded onto the bottom portion 135 or collapsed downward to the bottom portion 135 to form overlapping smaller circles 140. The present invention does not come apart in order to collapse or fold, rather it collapses on itself and/or folds onto itself to reduce its surface area, making it compact for easy storage and transport. The ability of the assembled bait net 105 to collapse or fold easily is facilitated by the permanent lock 100 of the fastener 90 that allows for a 360 degree range of rotation.

Thus, this embodiment of the present invention is a collapsible bait net comprising: two straight solid rods, with each rod having a solid first end and a solid second end; a fastener having a female component and male component irremovably joined together which irremovably connects the two straight solid rods together to form a closed ring, whereby the female component comprises: a hollow first end; a solid body contiguously adjacent to the hollow first end; a hollow second end contiguously adjacent to the solid body, and the second end having two notches positioned along the hollow second end between the solid body and the second end; and whereby the male component comprises: a hollow first end; a solid rounded second end; and a first, second, and third segment contiguously adjacent to each other located between the ends of the male component; whereby the first segment is a hollow cylindrical body located adjacent to the hollow first end and the second segment; whereby the second segment is a solid cylindrical body of lesser length than the first segment, and is located between the first segment and the third segment; whereby the third segment is a solid cylindrical body of lesser length than both the first and second segments, and is located between the second segment and the solid rounded second end of the male component; and whereby the second end and the second and third segments of the male component are inserted into the hollow second end of the female component to fit within the space between the hollow first end and the solid body of the female component; and whereby the third segment of the male component fits precisely within the space between the two notches of the female component; whereby pressure is applied to the notches which are compressed about the third segment of the male component, creating a permanent locking mechanism that allows for a 360 degree range of rotation about the connection point of the male and female components of the fastener for the rods; a net made of mesh, having a bottom portion and a top portion, which top portion has the same diameter as the closed ring and less than the bottom portion, which bottom portion extends into a conical shaped enclosed receptacle, forming a hoop; and the net is attached to the closed ring formed by the two rods irremovably connected to the irremovably joined fastener components to create a closed ring and net assembly; and four stabilizing cords, each separately attached to the closed ring and net assembly by a fastening means and positioned equidistant from each other about the closed ring, and which cords converge at the center of the closed ring and net assembly; and a draw cord that is attached to the four stabilizing cords at their point of convergence by a fastening means; and the closed ring and net assembly collapses for ease of storage and transport without the disassembly of any of its components by: holding the closed ring and net assembly at the irremovably joined fasteners in a symmetrically opposed position from each other; then rotating the rods to form a figure 8, where the fasteners intersect diagonally, creating a top portion and a bottom portion to the figure 8 arrangement; then folding the top portion of the figure 8 arrangement onto the bottom portion of the figure 8 arrangement to form two smaller overlapping circles.

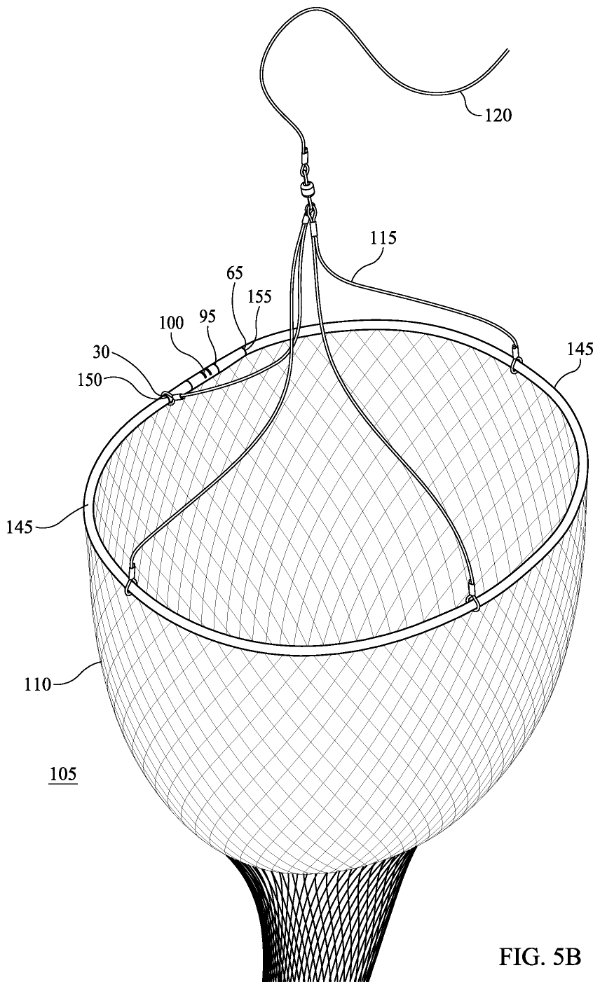

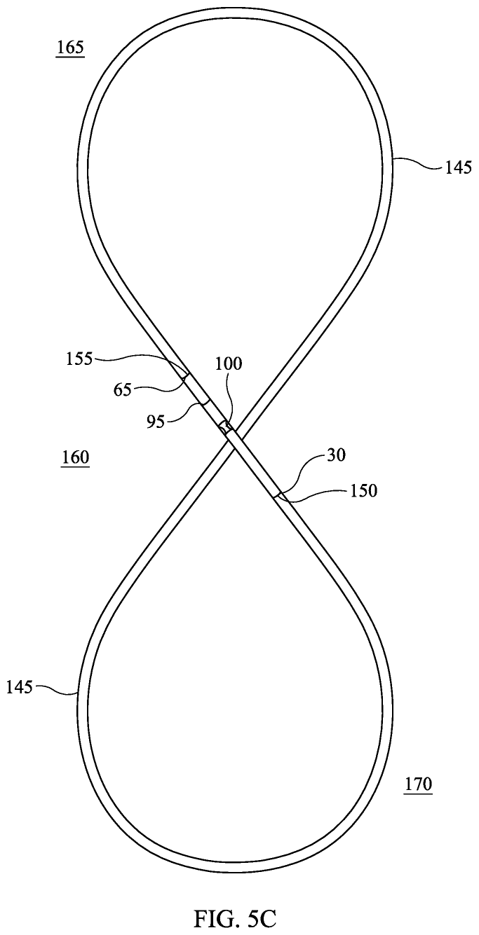

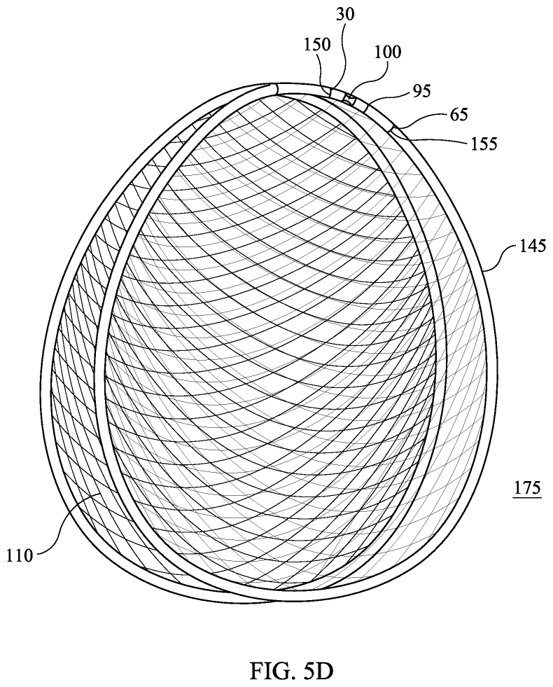

In another embodiment of this invention, the bait net 105 comprises one straight solid rod 145, having a first end 150 and a second end 155 as shown in FIG. 5A; one fastener 90 which has a female component 25 and a male 60 component that are joined together, as shown in FIGS. 1C and 1D; netting 110; four stabilizing cords 115; and a draw cord 120. FIG. 5B illustrates that the first end 30 of the female component 25 of the fastener 90 is connected to the first end 150 of the single rod 145; and the first end 65 of the male component 60 of the fastener 90 is connected to the second end 155 of the single solid rod 145. Before the solid rod 145 is connected to the fastener 90, the netting 110 is interwoven about the rod 145 along with the four stabilizing cords 115 and the draw cord 120.

For purposes of illustration, FIG. 5C demonstrates the steps for collapsing or folding the single rod 145 connected to the fastener 90, without the netting attached. First, a user holds the fastener 90 and a symmetrically opposing section of the bait net 105 ring formed by the single rod 145 together, and by rotating or twisting the rod 145 forms a large figure 8 160 (FIG. 5C), creating a top portion 165 and a bottom portion 170. Then the user folds the top portion 165 of the figure 8 160 downward until it overlaps with the bottom portion 170 of the figure 8 160 to form two smaller overlapping circles 175. FIG. 5D illustrates the same process for the fully assembled bait net 105, with netting 110, where the portions 165 and 170 of the figure 8 160 are collapsed or folded to form smaller overlapping circles 175. The present invention does not come apart or separate in order to collapse, but instead collapses on itself and/or folds onto itself to reduce its surface area, making it compact for easy storage and transport.

Thus, this embodiment of the present invention is collapsible bait net comprising: one straight solid rod, having a solid first end and a solid second end; a fastener having a female component and male component irremovably joined together which irremovably connects the ends of the straight solid rod together to form a closed ring, whereby the female component comprises: a hollow first end; a solid body contiguously adjacent to the hollow first end; a hollow second end contiguously adjacent to the solid body, and the second end having two notches positioned along the hollow second end between the solid body and the second end; and whereby the male component comprises: a hollow first end; a solid rounded second end; and a first, second, and third segment contiguously adjacent to each other and located between the ends; whereby the first segment is a hollow cylindrical body located adjacent to the hollow first end and the second segment; whereby the second segment is a solid cylindrical body of lesser length than the first segment, and is located between the first segment and the third segment; whereby the third segment is a solid cylindrical body of lesser length than both the first and second segments, and is located between the second segment and the solid rounded second end of the male component; and whereby the second end and the second and third segments of the male component are inserted into the hollow second end of the female component to fit within the space between the hollow first end and the solid body of the female component; and whereby the third segment of the male component fits precisely within the space between the two notches of the female component; whereby pressure is applied to the notches which are compressed about the third segment of the male component, creating a permanent locking mechanism that allows for a 360 degree range of rotation about the connection point of the male and female components of the fastener for the rod; a net made of mesh, having a bottom portion and a top portion, which top portion has the same diameter as the closed ring and lesser diameter than the bottom portion, which bottom portion extends into a conical shaped enclosed receptacle, forming a hoop; and the net is attached to the closed ring formed by the single solid rod irremovably connected to the irremovably joined fastener components to create a closed ring and net assembly; and four stabilizing cords, each separately attached to the closed ring and net assembly by a fastening means and positioned equidistant from each other about the closed ring, and which cords converge at the center of the closed ring and net assembly; and a draw cord that is attached to the four stabilizing cords at their point of convergence by a fastening means; and the closed ring and net assembly collapses for ease of storage and transport without the disassembly of any of its components by: holding the closed ring and net assembly at the irremovably joined fastener and a section of the solid rod in a symmetrically opposed position from each other; then rotating the rod to form a figure 8, where the fastener intersect diagonally with the section of the solid rod, creating a top portion and a bottom portion to the figure 8 arrangement; then folding the top portion of the figure 8 arrangement onto the bottom portion of the figure 8 arrangement to form two smaller overlapping circles.

In this single solid rod embodiment of the present invention, the rod 145 is made of fiber glass having the tensile strength to bend and twist without breaking. The level of flexibility of the fiber glass is very important to the ability of the bait net 105 to collapse or fold and unfold repeatedly without breaking. The single solid rod 145 may be made of durable and flexible plastics made from material such as epoxy resin, epoxy polymers, or other suitable polymers that allow for the required flexibility and strength. The single solid rod 145 may be made of any other durable and flexible material known by one of ordinary skill in the art to which this invention belongs.

In the embodiments of the invention described herein, the net or netting 105 may comprise of ¼″ mesh made of monofilament; and the four stabilizing cords 115 may be made of 300 lb. monofilament. The four stabilizing cords 115 converge to the center of the bait net 105 and are fastened together by means of a 10/0 stainless steel swivel and is further attached to the draw cord 120 which draw cord 120 may also be made of 300 lb. monofilament that is 25 feet long and ¼″ thick. The disclosed materials and dimensions of the components of the bait net 105 are not meant to be limiting, but illustrative and may be adjusted by one of ordinary skill in the art to which this invention belongs for optimal function.

In the embodiments of the present invention disclosed herein, the net or netting 110 may be made of mesh or similar fibers woven into a diamond-like structure or lattice-like structure as shown in FIGS. 2A, 2B, 4B, and 5A. However, in other embodiments of this invention the type of fiber used, and its pattern of weaving may be altered or substituted by one of ordinary skill in the art to which this invention belongs to achieve optimal function. The disclosed materials and dimensions of the components of the bait net 105 are not meant to be limiting, but illustrative and may be adjusted by one of ordinary skill in the art to which this invention belongs for optimal function.

In other embodiments of this invention, the net or netting 110 may comprise of materials including, but not limited to monofilament nylon, multifilament nylon, monofilament polyethylene nylon, multifilament polyethylene, knotless polyethylene netting, and/or clear twisted polyethylene. The net or netting 110 may comprise of any material synthetically derived or manufactured to have the same or similar structure and properties similar to that of nylon and/or polyethylene. Further, the net or netting 110 may comprise of other similar nylon and/or polyethylene materials known to one of ordinary skill in the art to which this invention belongs, including the art of marine netting.

In the embodiments of the invention described herein, the components 25, 60 of the fastener 90 are stainless steel, however they may be made of other strong non-corrosive metal known to one of ordinary skill in the art to which this invention belongs. More specifically, the components 25, 60 of the fastener 90 may be made of grade 316 stainless steel which is the standard molybdenum-bearing grade that provides better overall corrosion resistant properties than other grades of stainless steel. Other grades of stainless may be used, however the 316 grade is optimal for the use and function of the fastener 90 in this invention. The dimensions of the components 25, 60 of the fastener 90 may vary, including whereby the male and female components 25, 60 of the fastener 90 each have an even diameter of 5/16 inches. In other embodiments of the invention, the female component 25, 60 of the fastener 90 may have a conical shape where the first end 30 is narrower that the second end 35, which results in a tapering effect. This tapering effect provides a wider diameter for receiving the second end 85 of the male component 60 and facilitating space for the 360 degree range of rotation around the permanent lock 100 of the fastener 90.

In the embodiment of the invention having the single straight solid rod 145, the rod 145 may measure 12 ft in length for optimal functioning of the ring formed when the first end 150 and second end 155 are joined together by the fastener 90. In other embodiments, the single rod 145 may have a measurement greater than or less than 12 ft. In the embodiment of the present invention having two straight solid rods 5, the rods 5, 10 may measure Eft each in length or have other measurement greater or less than 6 ft each for optimal function. The disclosed dimensions of the straight solid rods 5, 10, and 145 are not meant to be limiting, but illustrative and may be adjusted by one of ordinary skill in the art to which this invention belongs for optimal function.

In other embodiments of this invention, the net 110 may comprise of materials including, but not limited to monofilament nylon, multifilament nylon, monofilament polyethylene nylon, multifilament polyethylene, knotless polyethylene netting, and/or clear twisted polyethylene. Further the net 110 may comprise of other similar nylon and/or polyethylene materials or netting. The net 110 may comprise of any material synthetically derived or manufactured to have the same or similar structure and properties similar to that of nylon and/or polyethylene.

In the embodiment of this invention described herein and/or other embodiments of this invention, the cords (115, 120) may be made of monofilament. In other embodiments the cords (115, 120) are not limited to this material, but may comprise of nylon or other material having the same or similar tensile strength and thickness of ordinary fishing line or other material of same or similar properties known to one of ordinary skill in the art to which this invention belongs. Further, the cords 115, 120 may comprise of materials including, but not limited to monofilament nylon, multifilament nylon, monofilament polyethylene nylon, multifilament polyethylene, knotless polyethylene netting, and/or clear twisted polyethylene. The cords 115, 120, may comprise of other similar nylon and/or polyethylene materials or netting. The cords 115, 120, may comprise of any material synthetically derived or manufactured to have the same or similar structure, tensile strength, and other properties similar to that of monofilament and/or nylon and/or polyethylene.

As various changes may be made in the above-described subject matter without departing from the scope and the spirit of the invention, it is intended that all subject matter contained in the above description, or shown in the accompanying drawings, will be interpreted as descriptive and illustrative, and not in a limiting sense. Many modifications and variations of the present invention are possible in light of the above teachings. It is therefore to be understood that within the scope of the appended claims, the invention may be practiced otherwise than as specifically described.

### EQUIVALENTS

Those skilled in the art will recognize or be able to ascertain using no more than routine experimentation, many equivalents to the specific embodiments of the invention described herein. Such equivalents are intended to be encompassed by the claims.

What is claimed is:

1. A collapsible bait net comprising:
a. two straight solid rods, with each rod having a solid first end and a solid second end;
b. a fastener having a female component and male component irremovably joined together which irremovably connects the two straight solid rods together to form a closed ring, whereby the female component comprises: a hollow first end; a solid body contiguously adjacent to the hollow first end; a hollow second end contiguously adjacent to the solid body, and the second end having two notches positioned along the hollow second end between the solid body and the second end; and whereby the male component comprises: a hollow first end; a solid rounded second end; and a first, second, and third segment contiguously adjacent to each other located between the ends of the male component; whereby the first segment is a hollow cylindrical body located adjacent to the hollow first end and the second segment; whereby the second segment is a solid cylindrical body of lesser length than the first segment, and is located between the first segment and the third segment; whereby the third segment is a solid cylindrical body of lesser length than both the first and second segments, and is located between the second segment and the solid rounded second end of the male component; and whereby the second end and the second and third segments of the male component are inserted into the hollow second end of the female component to fit within the space between the hollow first end and the solid body of the female component; and whereby the third segment of the male component fits precisely within the space between the two notches of the female component; whereby pressure is applied to the notches which are compressed about the third segment of the male component, creating a permanent locking mechanism that allows for a 360 degree range of rotation about the connection point of the male and female components of the fastener for the rods;
c. a net made of mesh, having a bottom portion and a top portion, which top portion has the same diameter as the closed ring and less than the bottom portion, which bottom portion extends into a conical shaped enclosed receptacle, forming a hoop; and
d. the net is attached to the closed ring formed by the two rods irremovably connected to the irremovably joined fastener components to create a closed ring and net assembly; and
e. four stabilizing cords, each separately attached to the closed ring and net assembly by a fastening means and positioned equidistant from each other about the closed ring, and which cords converge at the center of the closed ring and net assembly; and
f. a draw cord that is attached to the four stabilizing cords at their point of convergence by a fastening means; and
g. the closed ring and net assembly collapses for ease of storage and transport without the disassembly of any of its components by: holding the closed ring and net assembly at the irremovably joined fasteners in a symmetrically opposed position from each other; then rotating the rods to form a figure 8, where the fasteners intersect diagonally, creating a top portion and a bottom portion to the figure 8 arrangement; then folding the top portion of the figure 8 arrangement onto the bottom portion of the figure 8 arrangement to form two smaller overlapping circles.

2. The collapsible bait net in claim 1 whereby the fastener is made of grade 316 stainless steel and the solid rods are made of fiber glass.

3. The collapsible bait net in claim 1 whereby the fastener is made of grade 316 stainless steel and the rods are made of epoxy polymers.

4. A collapsible bait net comprising:
a. one straight solid rod, having a solid first end and a solid second end;
b. a fastener having a female component and male component irremovably joined together which irremovably connects the ends of the straight solid rod together to form a closed ring, whereby the female component comprises: a hollow first end; a solid body contiguously adjacent to the hollow first end; a hollow second end contiguously adjacent to the solid body, and the second end having two notches positioned along the hollow second end between the solid body and the second end; and whereby the male component comprises: a hollow first end; a solid rounded second end; and a first, second, and third segment contiguously adjacent to each other and located between the ends; whereby the first segment is a hollow cylindrical body located adjacent to the hollow first end and the second segment; whereby the second segment is a solid cylindrical body of lesser length than the first segment, and is located between the first segment and the third segment; whereby the third segment is a solid cylindrical body of lesser length than both the first and second segments, and is located between the second segment and the solid rounded second end of the male component;
and whereby the second end and the second and third segments of the male component are inserted into the hollow second end of the female component to fit within the space between the hollow first end and the solid body of the female component; and whereby the third segment of the male component fits precisely within the space between the two notches of the female component; whereby pressure is applied to the notches which are compressed about the third segment of the male component, creating a permanent locking mechanism that allows for a 360 degree range of rotation about the connection point of the male and female components of the fastener for the rod;
c. a net made of mesh, having a bottom portion and a top portion, which top portion has the same diameter as the closed ring and lesser diameter than the bottom portion, which bottom portion extends into a conical shaped enclosed receptacle, forming a hoop; and
d. the net is attached to the closed ring formed by the single solid rod irremovably connected to the irremovably joined fastener components to create a closed ring and net assembly; and
e. four stabilizing cords, each separately attached to the closed ring and net assembly by a fastening means and positioned equidistant from each other about the closed ring, and which cords converge at the center of the closed ring and net assembly; and
f. a draw cord that is attached to the four stabilizing cords at their point of convergence by a fastening means; and
g. the closed ring and net assembly collapses for ease of storage and transport without the disassembly of any of its components by: holding the closed ring and net assembly at the irremovably joined fastener and a section of the solid rod in a symmetrically opposed position from each other; then rotating the rod to form a figure 8, where the fastener intersect diagonally with the section of the solid rod, creating a top portion and a bottom portion to the figure 8 arrangement; then folding the top portion of the figure 8 arrangement onto the bottom portion of the figure 8 arrangement to form two smaller overlapping circles.

5. The collapsible bait net in claim 4 whereby the fastener is made of grade 316 stainless steel and the solid rod is made of fiber glass.

6. The collapsible bait net in claim 4 whereby the fastener is made of grade 316 stainless steel and the rod is made of epoxy polymers.
